(19) United States
(12) Patent Application Publication
(10) Pub. No.: US 2010/0250441 A1
(43) Pub. Date: Sep. 30, 2010

(54) METHOD AND SYSTEM FOR SECURING A PAYMENT TRANSACTION WITH TRUSTED CODE BASE ON A REMOVABLE SYSTEM MODULE

(75) Inventor: Paul D. Coppinger, Mesa, AZ (US)

Correspondence Address: SNELL & WILMER L.L.P. (Main), 400 EAST VAN BUREN, ONE ARIZONA CENTER, PHOENIX, AZ, 85004-2202, US

(73) Assignee: APPSWARE WIRELESS, LLC, Scottsdale, AZ (US)

(21) Appl. No.: 12/414,446

(22) Filed: Mar. 30, 2009

(51) Int. Cl. G06Q 20/00

(52) U.S. Cl. 705/67; 705/75

(57) ABSTRACT

A trusted code base is provided on a removable system module that is inserted in a mobile payment device 130. The trusted code base obtains a password from a customer for processing a payment transaction and encrypts the password using a public key. Access to the trusted code base by unauthorized processes is prevented to protect the password while unencrypted. The mobile payment device 130 transmits the encrypted password over a network 140 to a transaction host 160. The transaction host 160 decrypts the encrypted password and applies the decrypted password to process the payment transaction.

### FIELD OF THE INVENTION

The present invention relates to data security and, more particularly, the securing of data in payment transactions.

### BACKGROUND OF THE INVENTION

A modern point of sale system typically includes a terminal which accepts payment cards such as credit and debit cards. When a product is purchased, the merchant enters product and price information into the point of sale system. The customer may then initiate payment by swiping a payment card through a card reader or providing the card for the merchant to do so. The system then communicates via network with a transaction host that authorizes and processes the transaction on behalf of a financial institution that holds the account with which the payment card is associated.

In order to authorize the transaction, some form of authentication, such as a signature or password, must be provided by the paying customer. Debit card transactions, for example, typically require the customer to provide a personal identification number (PIN) which authenticates the customer to the transaction host. The customer enters the number into a PIN Entry Device (PED) and the system then provides the PIN via network to the transaction host. The transaction host uses the PIN to confirm the identity of the user, confirms sufficient funds are available, debits the customer's account by the payment amount, and communicates approval back to the point of sale system.

As it plays a critical role in controlling access to the customer's account, it is essential for the PIN to remain confidential. For this reason, security measures are applied to ensure the PIN is not discovered during the transaction. This includes encryption of the PIN, before it is transmitted from the point of sale system to the transaction host, into a format essentially undecipherable by anyone without a corresponding decryption key.

Conventional point of sale systems have typically employed symmetric (shared) key algorithms to encrypt the PIN. That is, the PIN is encrypted by the system using a secret key and then transmitted to the transaction host where it is decrypted using a secret key that is identical to the one used to encrypt it. For some types of transactions, symmetric key encryption is required by the transaction host. Electronic Benefit Transfer (EBT) transactions, for example, require the PIN to be encrypted with a shared secret key.

Maintaining an encryption key within the point of sale system leaves it potentially vulnerable to discovery. For this reason, the secret key used to encrypt the PIN is required to reside only within the PED into which the PIN is entered, and stringent physical requirements and regulations are applied to prevent physical or electronic tampering with the PED. Such measures may be prohibitively burdensome to merchants and, even when employed, may not entirely overcome the vulnerability of the shared secret key approach.

Furthermore, utilization of the symmetric key encryption approach described above essentially limits PIN-based transactions to fixed location PEDs because the lack of physical control renders it prohibitively expensive to secure a shared secret key in a mobile device such as a mobile phone or personal digital assistant.

It would therefore be desirable to provide a means for securing a payment transaction which overcomes the disadvantages inherent in the use of a symmetric key algorithm. It would also be desirable to provide a means for securing a payment transaction that utilizes a mobile device.

### BRIEF DESCRIPTION OF THE DRAWINGS

The invention is described in terms of the preferred embodiments set out below and with reference to the following drawings in which like reference numerals are used to refer to like elements throughout.

FIG. 1 is a block diagram illustrating a system in which a secure payment transaction is performed in accordance with an embodiment of the present invention.

FIG. 2 is a flow diagram illustrating a process performed by a mobile payment device to obtain a secure payment transaction in accordance with an embodiment of the present invention.

FIG. 3 is a flow diagram illustrating a process performed by a cryptographic conversion host to secure a payment transaction in accordance with and embodiment of the present invention.

FIG. 4 is a flow diagram illustrating a process performed by a transaction host to perform a secure payment transaction in accordance with an embodiment of the present invention.

### DETAILED DESCRIPTION OF THE PREFERRED EMBODIMENTS

A method is provided for obtaining a secure payment transaction on a mobile device. A password is obtained from a customer and encrypted with a public key. The encrypted password is provided over a network and decrypted with a corresponding private key. The decrypted password is then applied to process the payment transaction. In one embodiment, the public key encrypted password is transmitted to a cryptographic conversion host that decrypts the public key encrypted password with the corresponding private key, re-encrypts the password with a secret key, and then provides the secret key encrypted password to a transaction host that decrypts it with an identical secret key and applies the decrypted password to process the payment transaction.

In order to protect the initially unencrypted password, a trusted code base is provided for obtaining and encrypting the password. The trusted code base may be provided directly on the mobile device or, alternatively, on a removable system module such as a subscriber identity module residing on the mobile payment device. Access to the trusted code base by unauthorized processes is prevented to protect the password while unencrypted. The trusted code base can be digitally signed, and may include a digital certificate of the cryptographic conversion host.

The method and system described above provide the advantage of a secure payment transaction by providing end-to-end protection of a password utilized in the payment transaction. By preventing access to the password while unencrypted and then encrypting the password while transmitted from the mobile device to the transaction host, the password is protected from unintended discovery.

In embodiments where a cryptographic conversion host is provided to decrypt the public key encrypted password and re-encrypt it with a secret key before it is provided to the transaction host, the advantages of asymmetric key encryption are further provided to point of sale systems utilizing transaction hosts designed to accept symmetric key encrypted payment data. One advantage of enabling asymmetric key encryption in the point of sale system is that it allows for mobility of the payment device since it can utilize a public key to encrypt the payment data and is, therefore, no longer burdened with the restrictions associated with maintaining a secret key. This allows for password-based payment transactions to be performed by mobile devices such as PDAs and mobile phones, providing mobile payment capability with other practical functions in a single mobile communications device. Such transactions may include, for example, PIN-based electronic benefit transfer (EBT) transactions, where the EBT host is configured to receive and decrypt a symmetric key encrypted PIN. An aspect of the invention thus provides the capability of mobile payment for EBT transactions by utilizing asymmetric key encryption to encrypt the PIN in the mobile payment device and then converting the asymmetric key encrypted PIN to a symmetric key encrypted PIN as expected by the EBT host.

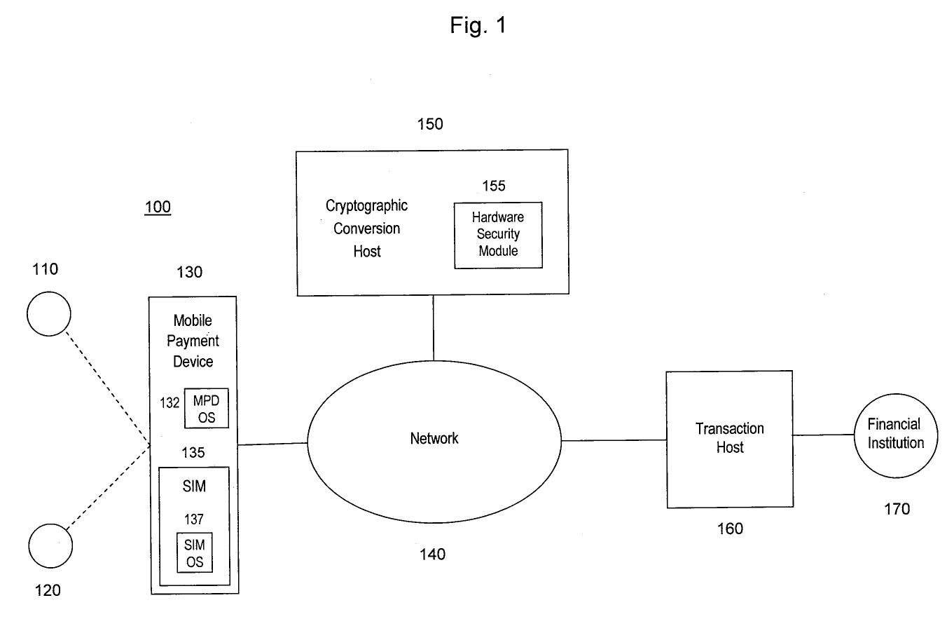

FIG. 1 is a block diagram illustrating a system in which a secure payment transaction is performed in accordance with an embodiment of the present invention. The system 100 shown in FIG. 1 provides for a secure payment transaction to be made for the sale of goods or services to a customer 110 by a merchant 120 who maintains a mobile payment device 130. The mobile payment device 130 may be, for example, a Personal Digital Assistant (PDA) or mobile phone configured to perform the payment functions described herein.

The mobile payment device 130 has a processor, volatile and nonvolatile memory, and other hardware and firmware elements operating in accordance with system and application software appropriate to the functions it provides. The mobile payment device 130 also includes a user interface with input means such as a keypad or touchpad through which information can be entered and display means such as a small display screen providing information to the user. The mobile payment device 130 includes a mobile payment device operating system (MPD OS) 132 which runs applications and performs other operating system functions appropriate for mobile devices such as mobile phones and PDAs.

The mobile payment device 130 also includes a subscriber identity module (SIM) 135. The subscriber identity module 135 is a smart card that is inserted in the mobile payment device 130. The subscriber identity module 135 contains data unique to the subscriber and can also be configured to control functions of the mobile payment device 130. The subscriber identity module 135 contains its own processor and memory and includes a subscriber identity module operating system (SIM OS) 137 that is capable of running independently of the mobile payment device operating system 132.

The mobile payment device 130 further includes a card reader through which a payment card such as a credit or debit card can be swiped. The card reader may be a magnetic stripe card reader, smart card reader, or any apparatus appropriate for reading data from a payment card. In the described embodiment, the card reader is an internal card reader included within the mobile payment device 130. Alternatively, the mobile payment device 130 can obtain the customer data from an external card reader (not shown) to which it is communicatively connected.

The system 100 includes a network 140 over which transaction data necessary to process the payment transaction is transmitted. The network 140 is any suitable telecommunications network having a wireless network component through which the mobile payment device 130 communicates, allowing the mobile payment device 130 to have mobile capability.

The system 100 is provided with a host, referred to herein as a cryptographic conversion host 150, which converts public key encrypted data into secret key encrypted data. The cryptographic conversion host 150 interfaces with the network 140 and includes a hardware security module 155 which generates and securely stores a private key it uses to decrypt the public key encrypted data and a secret key it uses to re-encrypt the decrypted data. One of ordinary skill in the art will recognize that the cryptographic conversion host 150 may be implemented in a number of different ways and may be, for example, part of a host system that performs other tasks such as data security functions.

The system 100 further includes a transaction host 160 which obtains transaction data via the network 140 and processes the payment transaction on behalf of a financial institution 170 that holds the account of the customer 110 for the payment card that has been used.

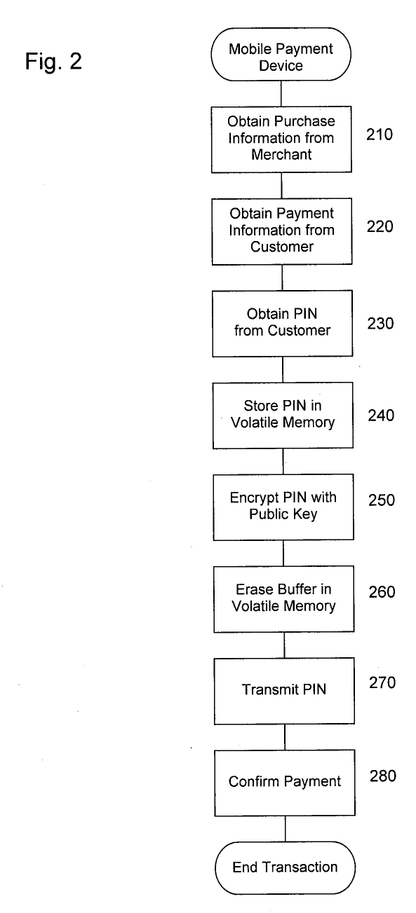

FIG. 2 is a flow diagram illustrating a process performed by the mobile payment device 130 to obtain a secure payment transaction in accordance with an embodiment of the present invention. In step 210, the mobile payment device 130 obtains from the merchant 120 purchase information such as the price of goods or services provided to the customer 110. In step 220, the mobile payment device 130 obtains payment information from the customer 110, such as an authorization to charge the purchase to his or her payment card. For example, customer 110 swipes an Electronic Benefit Transfer (EBT) card through the card reader of the mobile payment device 130.

In step 230, the mobile payment device 130 obtains a password from the customer 110. When certain types of payment cards are utilized, some form of password must be provided by the customer 110 to authenticate the customer to the financial institution that will process the payment. For example, when a debit card or EBT card is provided, the customer 110 is typically required to provide a Personal Identification Number (PIN.) One of ordinary skill will recognize, however, that depending on the type of payment card used, the application and the circumstances, alternative types of passwords may be used including alphabetic, numeric and other characters or values, or various combinations thereof and that the present invention can be readily adapted to secure transactions utilizing such alternative types of passwords.

Continuing with the example above where an EBT card has been provided in step 220, the mobile payment device 130 in step 230 obtains a PIN from the customer 110 via the input means provided by the mobile payment device 130, such as by the customer 110 entering the PIN on a keypad or touchpad of the mobile payment device 130. Where the keypad or touchpad is designed to emit a tone when pressed, and especially where different tones or tonal combinations are associated with different numeric or alpha-numeric selections such as with dual-tone multi-frequency (DTMF) tones, the PIN can be further protected from discovery by disabling tone emissions in the mobile payment device 130 during PIN entry.

In step 240, the mobile payment device 130 stores the PIN obtained from the customer 110 in volatile memory within the mobile payment device 130. In one advantageous embodiment, the PIN is stored in a buffer within the volatile memory that is locked to prevent any transference into a nonvolatile medium. This prevents the unencrypted PIN from being accessed by any other processes or recorded in any way that can be discovered thereafter.

In step 250, the mobile payment device 130 encrypts the PIN using an asymmetric (public key) cryptography algorithm. In an embodiment of the invention, the mobile payment device 130 applies an RSA algorithm utilizing Public Key Cryptography Standard (PKCS) #1 as defined by RSA Laboratories. Specifically, the mobile payment device 130 maintains an RSA public key previously generated by the hardware security module 155 of the cryptographic conversion host 150 which also generated and continues to maintain the corresponding RSA private key. The mobile payment device 130 places the PIN into the message portion of a PKCS #1 Type 2 encryption block and applies the RSA public key to encrypt the block. Immediately thereafter, in step 260, the mobile payment device 130 erases the buffer in nonvolatile memory in which the unencrypted PIN was stored.

During the time the unencrypted PIN resides on the mobile payment device 130 additional protections are provided to ensure it is not compromised. In an embodiment of the invention, the functionality (e.g., software and associated memory) that obtains and encrypts the PIN (e.g. performs steps 230 to 260) is provided by a trusted code base. The trusted code base (which may also be referred to as a trusted computing base) is isolated from unauthorized processes (e.g., all other active processes) running on the mobile payment device 130 so as to prevent access to the PIN.

In accordance with the description herein, one of ordinary skill will readily implement such a trusted code base in a manner consistent with the architecture of the mobile payment device 130. For example, a mobile payment device 130 running the Windows Mobile® operating system by Microsoft Corporation can employ the memory management unit (MMU) that is provided in the underlying computer system. As is known in the art, an MMU is a hardware component capable of handling access to the memory by the processor and can be utilized to prevent access to unauthorized processes.

Depending on the configuration utilized, greater security of the unencrypted PIN may be realized by providing additional protections. For operating systems environments that support code signing such as Windows Mobile® and Linux, for example, the trusted code base can be digitally signed. The digital signature can then be verified by the operating system before allowing execution of the trusted code base. This will ensure that the software that performs steps 230 to 260 has not been tampered with while stored on the mobile payment device 130. An additional advantage of digitally signing the trusted code base can be realized by compiling a digital certificate of the cryptographic conversion host 150 into the trusted code base before it is digitally signed. Verification of the trusted code base thus ensures that the digital certificate has not been modified, preventing, for example, substitution of a foreign certificate that could perpetuate a “man in the middle” attack.

In one embodiment, the trusted code base is provided directly on the mobile payment device 130. In an alternative embodiment, the trusted code base is provided on a removable system module such as a subscriber identity module (SIM) 135 that is inserted in the mobile payment device 130. As explained above, the subscriber identity module 135 is a removable smart card which includes its own memory, processor and subscriber identity module operating system 137 (e.g., Java Card) and can therefore prevent unintended access to the PIN by isolating the functionality that obtains and encrypts the PIN from other active processes running on the mobile payment device 130.

As the subscriber identity module 135 can be used to control primary functions of the mobile payment device 130, initial entry of the PIN can be adequately controlled by the SIM-based trusted code base so as to protect the PIN from discovery or compromise. The SIM operating system 137 functions independently of the mobile payment device operating system 132, and processes controlled by the SIM operating system 137 cannot be directly accessed by the operating system on the mobile payment device 130 or processes it controls.

Where appropriate, further protection of the PIN within the subscriber identity module 135 can be provided by limiting processes performed by the subscriber identity module 135 and/or by utilizing the security features native to the subscriber identity module operating system 137 to accomplish additional protection functions such as, where relevant, one or more of the trusted code base features described above. Providing the trusted code base on the subscriber identity module 135 also protects the PIN from discovery by physical means by automatically erasing stored data if the SIM card is tampered with.

In step 270, the mobile payment device 130 transmits the public key encrypted PIN via the network 140 to the cryptographic conversion host 150. Specifically, the mobile payment device 130 places the RSA public key encrypted PIN block into a transaction message and then transmits the transaction message to the cryptographic conversion host 150. One of ordinary skill will recognize that the transaction message could be implemented in a variety of ways. The transaction message can be, for example, an ISO 8583 message which contains the PIN block along with other data related to the transaction.

The mobile payment device 130 and cryptographic conversion host 150 secure the transmission using a cryptographic protocol such SSL 3.0 (Secure Sockets Layer version 3.0) which provides various security features including encryption, authentication and data integrity. One of ordinary skill will recognize that available protocols may change and improve over time, and will apply a means of securing the transmission that is appropriate for the application and circumstances at hand.

Thereafter, in step 280, the mobile payment device 130 awaits an acknowledgement of successful processing of the payment transaction and displays a confirmation to the user that the transaction has been completed. It should be understood in accordance with the above description that the mobile payment device 130 contains only the public key and not the corresponding private key. As a result, the mobile payment device 130 is not vulnerable to compromise of a key used to decrypt the PIN, as has been the case for conventional PIN entry devices which use a symmetric (shared secret key) cryptography algorithm.

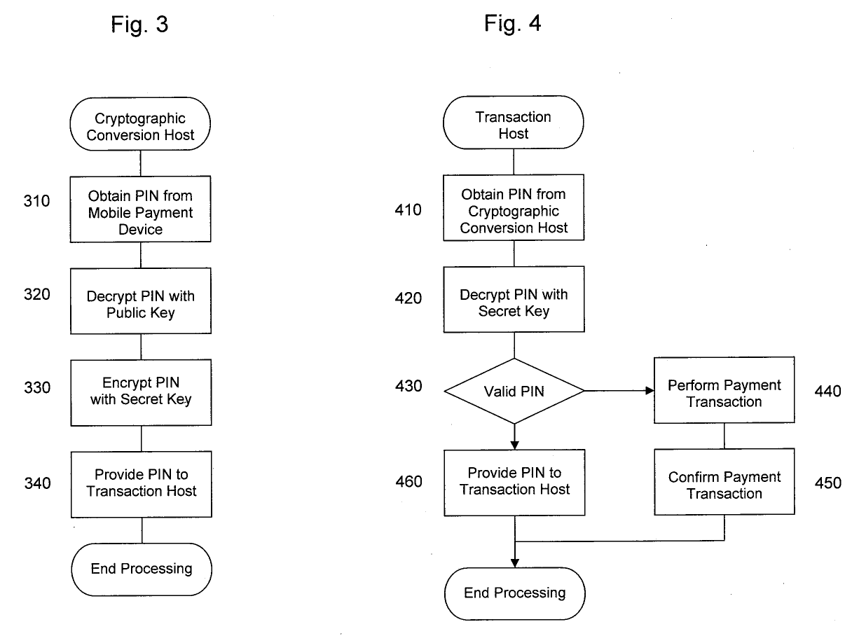

FIG. 3 is a flow diagram illustrating a process performed by the cryptographic conversion host 150 to secure a payment transaction in accordance with a specific embodiment of the present invention. In step 310, the cryptographic conversion host 150 obtains the public key encrypted PIN from the mobile payment device 130 via the network 140. Specifically, the cryptographic conversion host 150 obtains the transaction message described above from the mobile payment device 130 and extracts the RSA public key encrypted PIN block. The cryptographic conversion host 150 then passes the public key encrypted PIN block to the hardware security module 155.

In step 320, the cryptographic conversion host 150 decrypts the public key encrypted PIN. The hardware security module 155 securely maintains an RSA private key which corresponds to the RSA public key that was used by the mobile payment device 130 to encrypt the PIN. The hardware security module 155 applies the RSA private key to decrypt the RSA public key encrypted PIN block and extracts the PIN from the resulting decrypted PKCS #1 Type 2 encryption block.

In step 330, the cryptographic conversion host 150 re-encrypts the PIN using an asymmetric (secret key) cryptography algorithm. In an embodiment of the invention, the cryptographic conversion host 150 applies a Triple Data Encryption Standard (3DES) algorithm to encrypt the PIN. The hardware security module 155 securely maintains a 3DES secret key which is identical to a secret key maintained by the transaction host 160. The identical secret keys are generated, for example, by a Derived Unique Key Per Transaction (DUKPT) process. The hardware security module 155 applies the 3DES secret key to encrypt the PIN, placing it into an encrypted PIN block and then passing the encrypted PIN block back to the cryptographic conversion host 150.

In step 340, the cryptographic conversion host 150 replaces the RSA encrypted PIN block in the transaction message with the 3DES secret key encrypted PIN block and provides the transaction message to the transaction host 160. For example, the cryptographic conversion host 150 transmits the transaction message with the 3DES secret key encrypted PIN block to the transaction host 160 via the network 140.

FIG. 4 is a flow diagram illustrating a process performed by a transaction host to perform a secure payment transaction in accordance with the present invention. In step 410, the transaction host 160 obtains the secret key encrypted PIN from the cryptographic conversion host 150. Specifically, the transaction host 160 obtains the transaction message described above via, for example, the network 140 and extracts the secret key encrypted PIN block from the transaction message.

In step 420, the transaction host 160 decrypts the secret key encrypted PIN block. Specifically, the transaction host 160 stores a 3DES secret key that is identical to the 3DES secret key applied by the cryptographic conversion host 150 to encrypt the PIN block. The transaction host 160 applies the 3DES secret key to decrypt the 3DES secret key encrypted PIN block and extracts the PIN from the decrypted PIN block.

In step 430, the transaction host 160 determines whether the PIN is valid by comparing it to data associated with the account of the customer 110 the particular transaction. If the PIN is valid, the transaction host 160 performs the transaction in step 450, debiting the account of the customer 110 by the purchase amount, and confirms the transaction in step 460, sending an appropriate confirmation message back to the mobile payment device 130 via the network 140. If the PIN is not valid, the transaction host 160 sends a rejection message back to the mobile payment device 130 via the network 140.

The concepts discussed herein relating to the encryption, transmission and decryption of a password should be understood to include the encryption, transmission and decryption of data that is generated as a function of the password. For example, in the exemplary description above, a hash function may be applied to the PIN when it is entered into the mobile payment device 130. The resulting hash of the PIN, rather than the PIN itself, would thereafter be encrypted and transmitted by the mobile payment device 130. On the receiving end, upon decrypting the hash of the entered PIN it receives, the transaction host 160 would compare it to a hash of the expected PIN in order to confirm validity of the PIN and perform the transaction.

The invention has been described above with reference to one or more illustrative embodiments. Based on this description, further modifications and improvements may occur to those skilled in the art. The claims are intended to cover all such modifications and changes as fall within the scope and spirit of the invention.

What is claimed is:

1. A method for obtaining a secure payment transaction, the method performed by a mobile device and comprising the steps of:
(a) providing a subscriber identity module having a trusted code base for obtaining a password from a customer and encrypting the password;
(b) preventing access to the trusted code base by unauthorized processes; and
(c) transmitting the encrypted password via a network to a transaction host that decrypts the password and applies the decrypted password to process the payment transaction.

2. The method of claim 1 wherein the payment transaction is an electronic benefit transfer transaction.

3. The method of claim 1 wherein the mobile device is a mobile phone

4. The method of claim 1 wherein the mobile device is a personal digital assistant.

5. The method of claim 1 wherein step (a) provides a subscriber identity module operating system and step (b) prevents access to the trusted code base by processes not controlled by the subscriber identity module operating system.

6. A mobile device for obtaining a secure payment transaction, the mobile device comprising:
(a) a subscriber identity module having a trusted code base to which access by unauthorized processes is prevented, the trusted code base obtaining a password from a customer and encrypting the password; and
(b) means for transmitting the public key encrypted password via a network to a transaction host that decrypts the encrypted password and applies the decrypted password to process the payment transaction.

7. The mobile device of claim 6 wherein the payment transaction is an electronic benefit transfer transaction.

8. The mobile device of claim 6 wherein the mobile device is a mobile phone.

9. The mobile device of claim 6 wherein the mobile device is a personal digital assistant.

10. The mobile device of claim 6 wherein the subscriber identity module comprises a subscriber identity module operating system and access to the subscriber identity module is prevented by processes not controlled by the subscriber identity module operating system.

11. A method for obtaining a secure payment transaction, the method performed by a mobile device and comprising the steps of:
(a) providing a removable system module having a trusted code base for obtaining a password from a customer and encrypting the password with a public key;
(b) preventing access to the trusted code base by unauthorized processes; and
(c) transmitting the public key encrypted password via a network to a cryptographic conversion host that decrypts the public key encrypted password with a private key, encrypts the decrypted password with a secret key and provides the secret key encrypted password to a transaction host that decrypts the secret key encrypted password with an identical secret key and applies the decrypted password to process the payment transaction.

12. The method of claim 11 wherein the payment transaction is an electronic benefit transfer transaction.

13. The method of claim 11 wherein the mobile device is a mobile phone

14. The method of claim 11 wherein the mobile device is a personal digital assistant.

15. The method of claim 11 wherein step (a) provides a removable system module operating system and step (b) prevents access to the trusted code base by processes not controlled by the removable system module operating system.

16. The method of claim 11 wherein the removable system module is a smart card.

17. The method of claim 11 wherein the removable system module is a subscriber identity module.

18. A mobile device for obtaining a secure payment transaction, the mobile payment device comprising:
(a) a removable system module having a trusted code base to which access by unauthorized processes is prevented, the trusted code base obtaining a password from a customer and encrypting the password with a public key; and
(b) means for transmitting the public key encrypted password via a network to a cryptographic conversion host that decrypts the public key encrypted password with a private key, encrypts the decrypted password with a secret key and provides the secret key encrypted password to a transaction host that decrypts the secret key encrypted password with an identical secret key and applies the decrypted password to process the payment transaction.

19. The mobile device of claim 18 wherein the payment transaction is an electronic benefit transfer transaction.

20. The mobile device of claim 18 wherein the mobile device is a mobile phone.

21. The mobile device of claim 18 wherein the mobile device is a personal digital assistant.

22. The mobile device of claim 18 wherein the removable system module comprises a removable system module operating system and access to the removable system module is prevented by processes not controlled by the removable system module operating system.

23. The mobile device of claim 18 wherein the removable system module is a smart card.

24. The mobile device of claim 18 wherein the removable system module is a subscriber identity module.
